(19) United States
(12) Patent Application Publication
(10) Pub. No.: US 2009/0314512 A1
(43) Pub. Date: Dec. 24, 2009

(54) CONDUIT BODY WITH CURVED LIP

(76) Inventor: Kenneth Garry Bing, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/145,195

(22) Filed: Jun. 24, 2008

(51) Int. Cl. H02G 3/04

(52) U.S. Cl. 174/81; 174/68.3; 174/74 R

(57) ABSTRACT

A conduit body for wires or cables with a curved lip on the inlet that allows a user to manipulate less hazardously wires or cables placed through the chamber of the conduit body.

### BACKGROUND OF THE INVENTION

The invention relates to the field of conduits for electrical wiring, telecommunications cables, and optical fiber data cables, and in particular to conduit bodies associated with the same.

People use electricity in association with their personal and business lives. As a consequence, the edifices in which people live and transact business must supply and accommodate the people's use of electricity. Electricity is often supplied to the edifice from an external source. The edifice then supplies electricity to various areas of the edifice, for use in lighting, appliances, and other electrical devices.

Electricity travels through electrical wires. Thus, the typical edifice has electrical wires entering the edifice from the external electricity supply and through the edifice, to supply electricity to the various areas of the edifice.

Metal or plastic often surrounds the electrical wiring coming into and traversing through an edifice. In other words, many edifices utilize a piping system for the routing of electrical wires. Artisans typically refer to the metal or plastic pipes of the piping system as “conduits.” National or local governments may regulate the use, form, and installation of electrical wiring conduits. Materials other than metal or plastic can form the conduit. The conduits can have a variety of physical properties, such as impact, moisture, and fire resistances.

In addition to electrical wires, conduits are used to route telecommunications cables, optical fiber data cables, among other cables. Collectively, such wires and cables are referred to herein as flexible conductors.

A conduit body is used when the route of an electrical wire must change direction, when a pair of wires initially traveling in the same route must diverge, or when it is convenient to use a conduit body to attach two conduit pipes together. For example, an artisan could use a conduit body to cause a ninety degree angular change in the route of an electrical wire. Like conduits, a conduit body can have a variety of physical properties, often protecting the wire or cable traveling through the conduit body. Artisans sometimes refer to a conduit body as an “ELL.”

Some conduit bodies utilize an inlet. The inlet provides access into the conduit. The inlet can allow the user to grasp more easily the wire or cable running through the conduit. The inlet can also be used to feed the wire or cable into the conduit body for routing through the conduit and through hubs or openings disposed in the conduit for distribution to the various areas of the edifice.

However, the inlets of present conduit bodies have sharp edges. Those sharp edges can cut into wires or cables, particularly when the user is pulling those wires or cables through the conduit. In addition, those sharp edges can cut the user's skin (such as the hand or finger) while the user manipulates the conduit body.

### BRIEF SUMMARY OF THE INVENTION

The conduit body of the present invention has the object of providing an improved conduit body that will not easily cut wires, cables, or the user's skin while manipulating the conduit body. The inlet of the conduit body has a curved lip. The inlet with a curved lip may be formed as a contiguous portion of the conduit body or may be detachably attached to the conduit body. The conduit body may also utilize one or more hubs, which provide access into the conduit body for a wire or cable.

In particular, the conduit body for a wire or cable includes a chamber that defines at least a partial enclosure. The chamber has openings that define passageways communicating with the chamber, where the openings into the chamber include a first hub, a second hub, and an inlet. The number of hubs, though, may vary, depending on the shape and intended purpose of the conduit body (e.g., three or more hubs). The inlet includes a curved lip defining an arcuate surface to facilitate manipulation of a wire or cable relative the conduit body.

While embodiments of the conduit body are herein illustrated and described, it is to be appreciated that various changes, rearrangements and modifications may be made therein, without departing from the scope of the invention as defined by the appended claims.

### BRIEF DESCRIPTION OF THE SEVERAL VIEWS OF THE DRAWINGS

FIG. 1 shows a perspective view of one embodiment of the disclosure.

FIG. 2 shows a side view of one embodiment of the disclosure.

FIG. 3 shows a front view of one embodiment of the disclosure.

FIG. 4 shows an end view of one embodiment of the disclosure.

FIG. 5 shows a top view of one embodiment of the disclosure.

FIG. 6 shows a bottom view of one embodiment of the disclosure.

FIG. 7 shows a perspective view of one embodiment of the disclosure, with a cover.

FIG. 8 shows an exploded perspective view of a second embodiment of the disclosure.

FIG. 9 shows a side view of a second embodiment of the disclosure.

FIG. 10 shows a top view of a second embodiment of the disclosure.

FIG. 11 shows a bottom view of a second embodiment of the disclosure.

FIG. 12 shows a perspective view of a third embodiment of the disclosure.

FIG. 13 shows a side view of a third embodiment of the disclosure.

FIG. 14 shows a top view of a third embodiment of the disclosure.

### DETAILED DESCRIPTION OF THE INVENTION

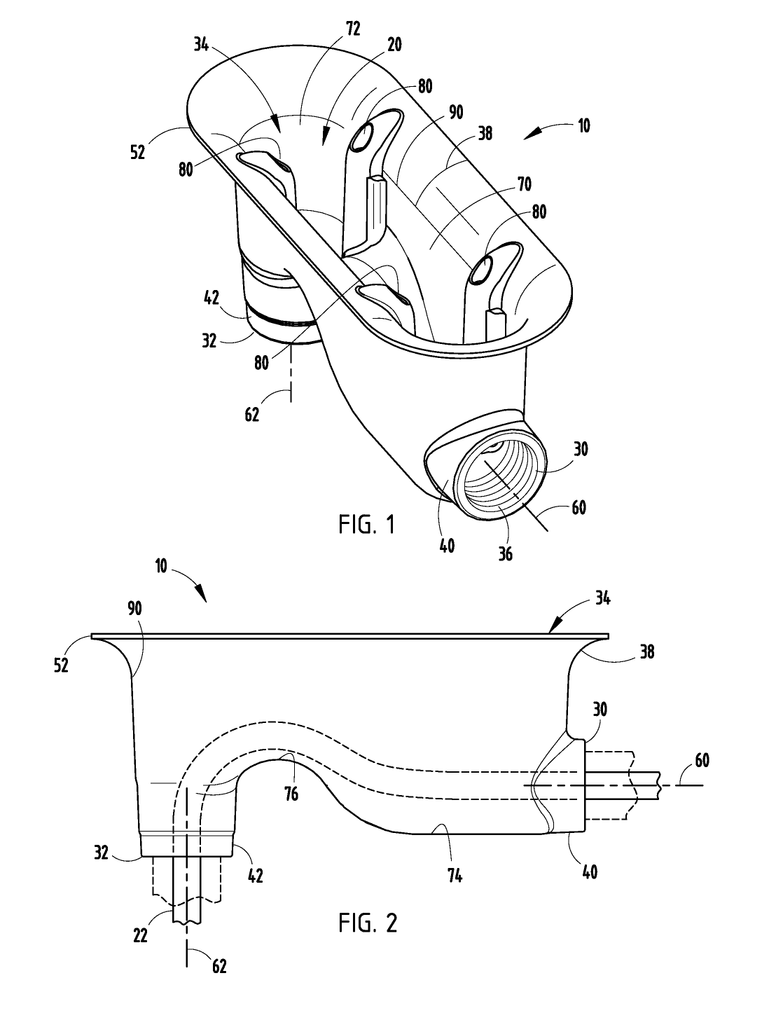

As depicted in the Figures, particularly FIG. 1, the present disclosure includes an improved conduit body 10. The conduit body 10 can be fabricated from a variety of materials, such as metals or plastic. The metals possible include aluminum, cast iron and zinc alloys. The conduit body 10 can additionally be formed via molded polymers, such as PVC.

The structure of the conduit body 10 forms a chamber 20. The chamber 20 defines at least a partial enclosure. The chamber 20 is the volume of the conduit body 10 through which a flexible conductor 22 can pass, as FIG. 2 shows.

The conduit body 10 has openings into the chamber 20. In this embodiment, the openings are a first hub 30, a second hub 32, and an inlet 34. The openings allow physical access into the chamber 20 of the conduit body 10. The openings define passageways communicating with the chamber 20.

In practice, a flexible conductor will often travel through one hub then through the internal enclosure of the conduit body, then through another hub to proceed out of the conduit body. For example, in the embodiment of FIG. 1, a flexible conductor (not shown) could travel into the conduit body 10 via the first hub 30, then through the chamber 20, and out through the second hub 32. The conduit body 10 has thus caused a ninety degree change of direction of the flexible conductor running through the conduit body 10. FIG. 2 shows an example of a flexible conductor 22 placed in the chamber 20, with the flexible conductor extending out the first hub 30 and out the second hub 32.

Alternatively, a flexible conductor 22 may travel through one hub, then be spliced into a second flexible conductor within the chamber 20 of the conduit body 10, where the second flexible conductor enters into the chamber 20 of the conduit body 10 through a second hub and is then passed through yet another third hub (not shown) to proceed out of the conduit body. Such a three hub conduit body is commonly referred to as a “T-type” conduit body.

The hubs can be threaded to allow the conduit body 10 to attach to a conduit, which is typically a length of straight conduit (not shown). In this embodiment, both the first hub 30 and the second hub 32 use threads 36, as shown in FIG. 1. The conduit body could use other means of attachment to a conduit, such as cement or clamps.

The inlet 34 allows the user to access physically the chamber 20 of the conduit body 10. Physical access into the chamber 20 allows the user to manipulate a flexible conductor 22 traveling through the conduit body 10. For example, after guiding a flexible conductor 22 through the first hub 30 and into the chamber 20, the user could access the flexible conductor 22 in the chamber 20 by placing the user's fingers through the inlet 34 and pull more length of the wire through the first hub 30. The user is then holding an excess length of flexible conductor 22, which the user could then push through the second hub 32. The inlet 34 can also be used to feed the flexible conductor 22 into the chamber 20 of the conduit body 10 for routing through the conduit body 10 and through hubs or openings disposed in the conduit body 10 for distribution to the various areas of the edifice. The inlet 34 could be any size.

The inlet 34 has a curved lip 38. The curved lip 38 defines an arcuate surface. The arcuate surface facilitates manipulation of a flexible conductor 22 relative the conduit body 10. For example, when a user reaches through the inlet 34 to grasp a flexible conductor 22, the curved lip 38 helps prevent the conduit body 10 from cutting the user's finger(s), thumb, or hand. A typical conduit body in use before the advent of this invention that does not incorporate the curved lip of the instant disclosure tends to cut the user's fingers, thumbs, and hands, when the user reaches through the inlet in order to manipulate a flexible conductor, because the inlet's edge is sharp. In addition, when a user pulls a flexible conductor through the chamber 20, the curved lip 38 helps prevent the conduit body 10 from cutting into the flexible conductor. A typical conduit body used before the advent of this invention, which does not incorporate the presently disclosed curved lip, tends to cut the flexible conductor, when the user pulls the wire or cable through the chamber, because the inlet's edge is sharp. At a minimum, scuffing of the insulating and protecting sheath of the flexible conductor can occur, potentially creating an exposed conducting element in the conductor.

The curved lip 38 can be continuous around the entirety of the inlet 34, as shown in FIG. 1. However, the entirety of the inlet 34 need not have a curved lip. Rather, portions of the inlet 34 could have a curved lip, while the remaining portions of the inlet 34 could have no curved lip.

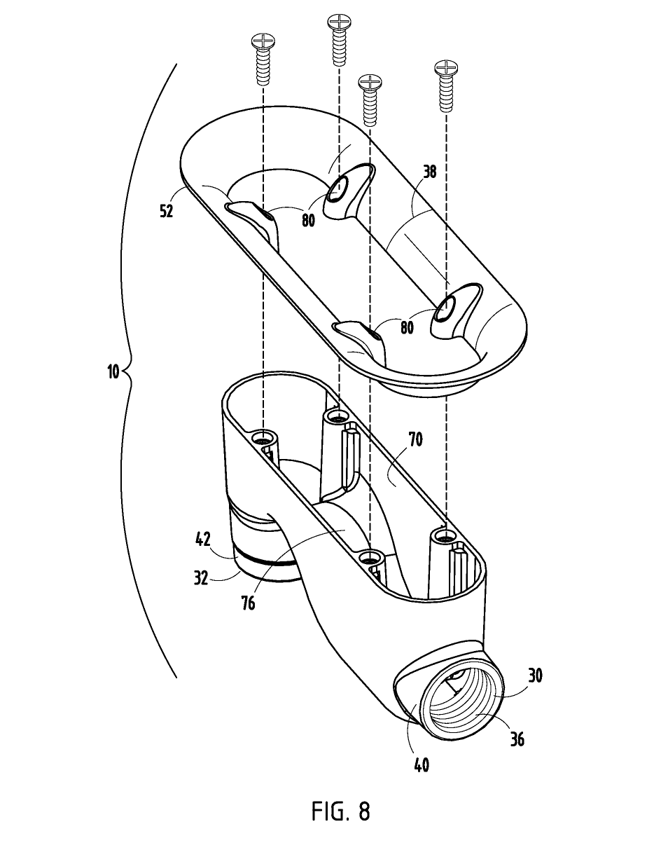

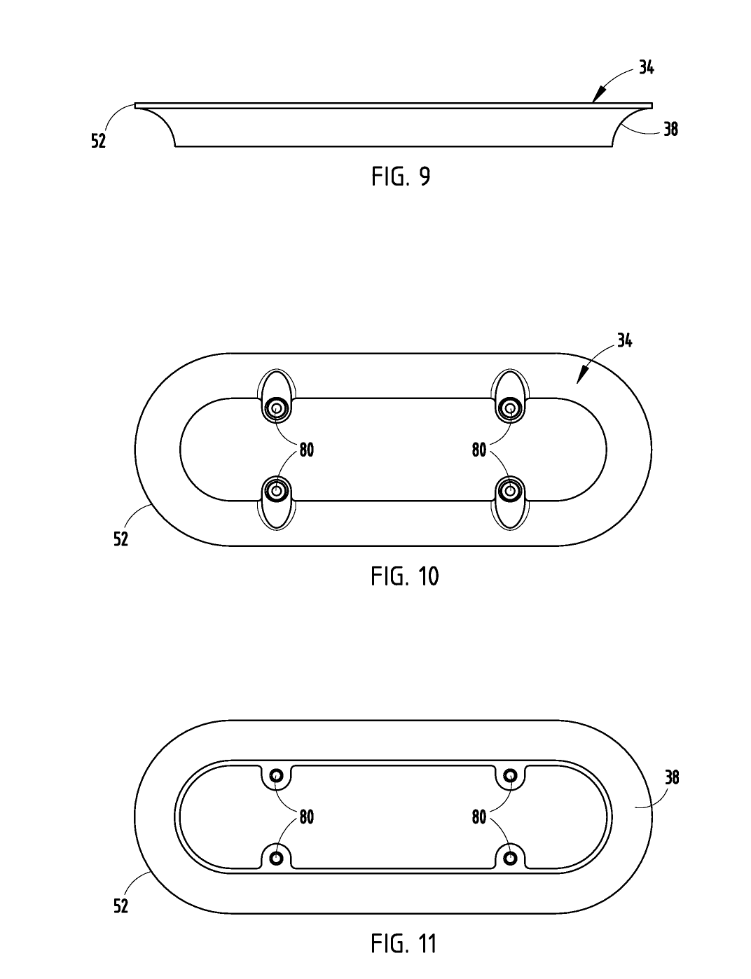

The curved lip 38 may be an integrated portion of the conduit body 10, as shown in FIG. 1. However, the curved lip 38 need not be integral. Instead, the curved lip 38 could be formed as a piece separate from the remainder of the conduit body 10 and could be detachably attached to the conduit body 10. This possibility is shown in FIGS. 8-11, where curved lip 38 is disclosed as a separate piece. The use of such a separated curved lip 38 allows the user to retro-fit a currently existing conduit body 10 by attaching the curved lip 10 to the conduit body 10 as shown in FIG. 8. The curved lip 38 can be attached through the four bosses 80 of the conduit body 10 formerly used only to detachably receive a cover.

As FIG. 1 shows, the first hub 30 can have a cylindrical portion 40. The cylindrical portion 40 provides an extended cylindrical surface area attached to the conduit body 10 for the placement of threads 36. The cylindrical portion 40 should provide sufficient volume to allow one or more flexible conduits to proceed through the hub. The second hub 32 can have a cylindrical portion 42, as well. However, none of the hubs need to have a cylindrical portion 40.

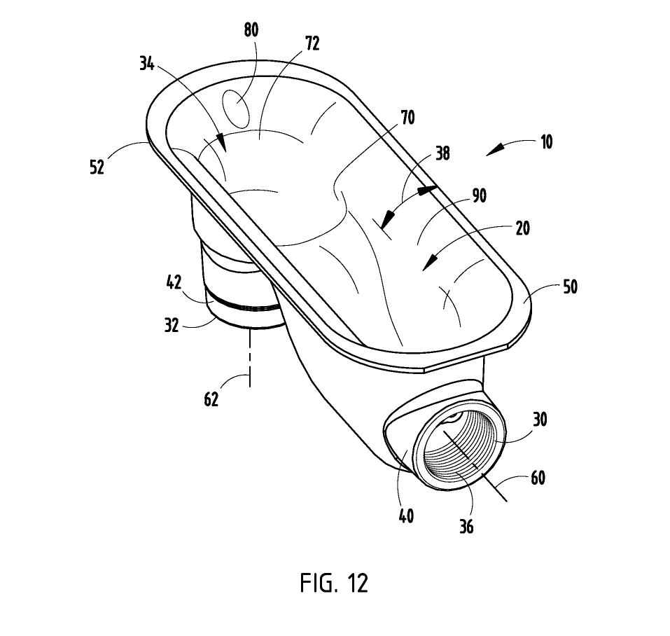

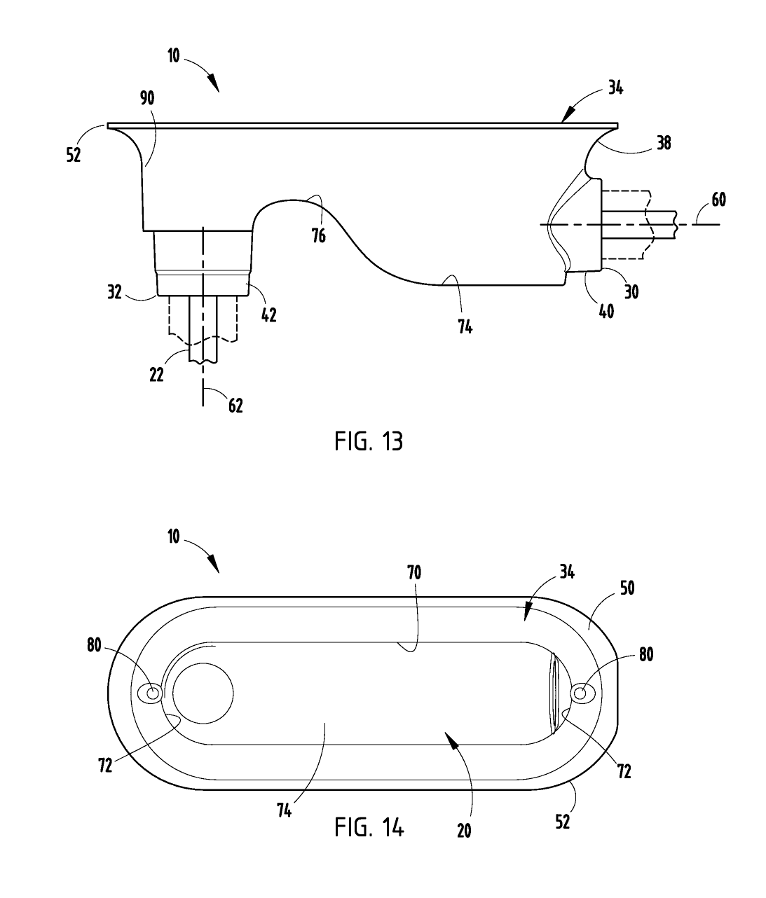

As FIGS. 12 through 14 show, the curved lip 38 of the conduit body 10 can provide a flat surface 50 proximate to the periphery 52 of the curved lip 38. However, as FIG. 1 shows, the curved lip 38 need not provide such a flat surface. When the curved lip 38 does provide such a flat surface 50, the flat surface can exist in the same plane.

In some embodiments, as shown in FIGS. 12 through 14, the cylindrical portion 40 of the first hub 30 has an axis 60 that is substantially parallel to the plane of the flat surface 50. Similarly, the cylindrical portion 42 of the second hub 32 can have an axis 62 that is substantially perpendicular to the axis 60 of the cylindrical portion 40 of the first hub 30. However, for a conduit body 10 that has only two hubs, the axis provided by the cylindrical portion 30 of the first hub 40 can exist in any angular relationship to the axis provided by the cylindrical portion 32 of the second hub 42. For a conduit body that has three (or more) hubs, the axes provided by the cylindrical portions of the hubs can exist in any angular relationship relative to any other hub.

The chamber 20 may further comprise longitudinal walls 70, end walls 72, and a side wall 74, in addition to the openings. The side wall 74 can provide a flexible conductor guide surface 76. The flexible conductor guide surface 76 provides a minimum radius of curvature to a flexible conductor 22 entering first hub 30, traveling through chamber 20, over the flexible conductor guide surface 76, and exiting second hub 32. Among other benefits, the flexible conductor guide surface 76 prevents a flexible conductor extending through the chamber 20 of the conduit body 10 from crimping. A full description of the flexible conductor guide surface and the benefits of such are set forth in U.S. Pat. No. 6,580,029 B1 (issued Jun. 17, 2003), the entirety of which is incorporated herein by reference.

The flexible conductor guide surface 76 provides a curved surface. However, other shaped surfaces could be used, so long as the result is the imparting of a curvature to the flexible conductor extending through the chamber 20. In the FIGS., the flexible conductor guide surface 76 is adjacent to the second hub 32, although the flexible conductor guide surface 76 could be positioned elsewhere (so long as the result is the imparting of sufficient curvature to the flexible conductor 22 extending through the chamber 20).

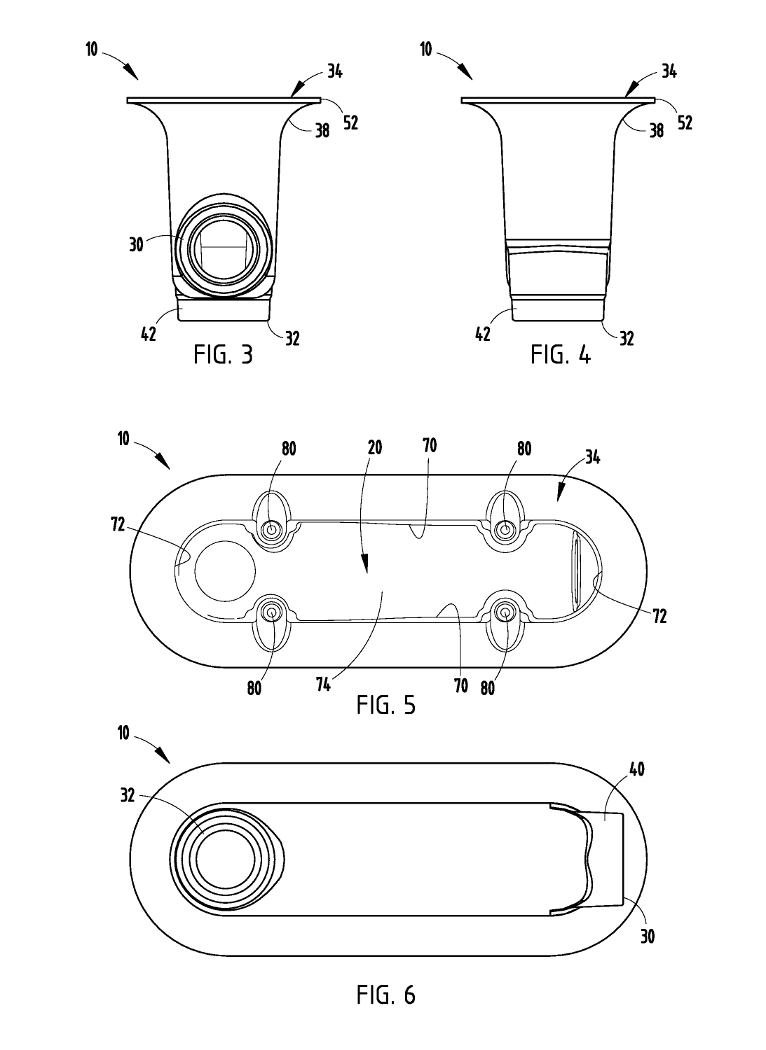

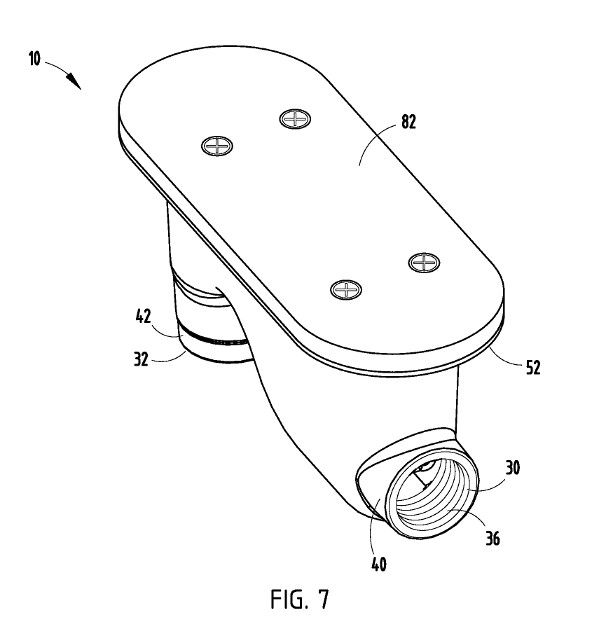

A cover 82 can close part or the entirety of the inlet 34 opening into the chamber 20 of the conduit body 10, as shown in FIG. 7. Thus, the chamber 20 can be adapted to detachably receive a cover 82. For example, the chamber 20 can have two bosses 80 to detachably receive the cover, as the embodiment of FIGS. 12 through 14 shows. For another example, the chamber 20 of the embodiment of FIGS. 1 through 7, has four bosses 80 to detachably receive the cover. The chamber 20 can use any number of bosses 80 as well as other non-boss means to detachably receive the cover. Other methods of attaching the cover can be used, such as detachably attaching the cover to the periphery 52 of the inlet 34 of the chamber 20. As noted above, where the curved lip 38 is formed as a piece separate from the remainder of the conduit body 10 and detachably attached to the conduit body, the cover 82 can be likewise attached through the same bosses 80 and associated fasteners used to detachably receive the cover 82.

As FIGS. 12 through 14 show, the chamber 20 can comprise longitudinal walls 70, end walls 72, and a side wall 74, in addition to the openings, and substantial portions of those walls are straight in the dimension perpendicular to the plane formed by the flat surface 50. The curvature of the curved lip 38 of the inlet 34 can begin at the curvature beginning 90, which is the point of transition between the straight portions of the walls of the chamber 20 and the curved lip 38. The curvature beginning 90 can substantially abut the first hub 30, as shown in the embodiment of FIGS. 12 through 14. In addition, there can be a more substantial separation between the curvature beginning 90 and the first hub 30, as shown in the embodiment of FIGS. 1 through 8.

While preferred embodiments and example configurations have been shown and described, it is to be understood that various further modifications and additional configurations will be apparent to those skilled in the art. It is intended that the specific embodiments and configurations disclosed are illustrative of the preferred and best modes for practicing the invention as defined by the appended claims, and should not be interpreted as limitations on the scope of the invention as defined by the appended claims and it is to be appreciated that various changes, rearrangements and modifications may be made therein, without departing from the scope of the invention as defined by the appended claims.

What is claimed is:

1. A conduit body for a flexible conductor comprising:
a chamber defining at least a partial enclosure, the chamber having openings defining passageways communicating with the chamber,
the openings into the chamber comprising a first hub, a second hub, and an inlet,
the inlet comprising a curved lip defining an arcuate surface to facilitate manipulation of a wire or cable relative the conduit body.

2. The conduit body as set forth in claim 1, wherein the curved lip is integral with the conduit body and contiguous around the inlet.

3. The conduit body as set forth in claim 1, wherein the curved lip is contiguous around the inlet and detachably coupled with the conduit body.

4. The conduit body as set forth in claim 1, wherein the first hub and second hub comprise a cylindrical portion.

5. The conduit body as set forth in claim 1, the curved lip including as a portion thereof a flat surface proximate the periphery of the curved lip.

6. The conduit body as set forth in claim 5, the flat surface forming a plane.

7. The conduit body as set forth in claim 6, wherein the cylindrical portion of the first hub has an axis substantially parallel to the plane of the flat surface.

8. The conduit body as set forth in claim 7, wherein the cylindrical portion of the second hub has an axis substantially perpendicular to the axis of the first hub.

9. A conduit body for a flexible conductor comprising:
a chamber comprising integral longitudinal walls, end walls, and a side wall, and openings defining passageways communicating with the chamber,
the openings into the chamber comprising a first hub, a second hub, and an inlet,
the inlet comprising a curved lip defining an arcuate surface to facilitate manipulation of a wire or cable relative the conduit body, and
one of the walls of the chamber comprising a wire or cable guide surface,
the wire or cable guide surface providing a predetermined minimum radius of curvature.

10. The conduit body as set forth in claim 9, the flexible conductor guide surface comprising a curved surface.

11. The conduit body as set forth in claim 10, the curved surface of the flexible conductor guide being adjacent to the second hub.

12. The conduit body as set forth in claim 9, wherein the curved lip is integral with the conduit body.

13. The conduit body as set forth in claim 11, wherein the curved lip is detachably coupled with the conduit body.

14. The conduit body as set forth in claim 9 wherein the chamber is further adapted to detachably receive a cover.

15. The conduit body as set forth in claim 14, wherein the chamber comprises two bosses to detachably receive the cover.

16. The conduit body as set forth in claim 9, wherein the chamber has a substantially straight walled configuration and the curved lip further comprises a curvature beginning, and transitioning from the straight walls of the chamber.

17. The conduit body as set forth in claim 9, wherein the curved lip further comprises a curvature beginning at and abutting the first hub.

18. The conduit body as set forth in claim 17 further comprising a cover detachably attached to an outer periphery of the inlet of the chamber and substantially covering the inlet.

19. A conduit body for a flexible conductor comprising:
a chamber and openings into the chamber, wherein
the openings into the chamber comprise a first hub, a second hub, and an inlet,
the inlet comprises a curved lip,
the curved lip is contiguous around the inlet and comprises a flat surface,
the flat surface forms a plane,
the first hub and second hub comprise a cylindrical portion,
the curved lip further comprises a curvature beginning,
the chamber further comprises straight walls that separate the curvature beginning and the first hub,
the chamber further comprising a cable guide surface, wherein the cable guide surface forces a cable placed through the first hub, through the chamber, over the cable guide surface, and through the second hub to have at least a minimum radius of curvature,
the cable guide surface comprising a curved surface,
the curved surface of the cable guide being adjacent to the second hub,
the chamber further comprising means to receive a cover,
the means to receive a cover.

20. A method of installing conduit body for a flexible conductor within a building comprising using the conduit body as set forth in claim 19.
